(19) United States
(12) Patent Application Publication
(10) Pub. No.: US 2026/0184185 A1
(43) Pub. Date: Jul. 2, 2026

(54) SYSTEMS AND METHODS FOR BRAKE TORQUE DISTRIBUTION

(71) Applicant: Daimler Truck North America LLC, Portland, OR (US)

(72) Inventors: Sachin Channarayapatna NAGENDRA, Portland, OR (US); Oliver Keith MERTEN, Portland, OR (US)

(21) Appl. No.: 19/417,184

(22) Filed: Dec. 11, 2025

Related U.S. Application Data
(60) Provisional application No. 63/739,813, filed on Dec. 30, 2024.

(51) Int. Cl. B60L 7/18; B60L 7/26

(52) U.S. Cl. CPC B60L 7/18; B60L 7/26; B60L 2240/12; B60L 2240/16; B60L 2240/18; B60L 2240/24; B60L 2240/465; B60L 2240/54; B60L 2240/662; B60L 2250/26

(57) ABSTRACT

A vehicle system can comprise a vehicle chassis with or more primary axles and one or more auxiliary axles, a powertrain comprising at least one electric motor coupled to the primary axles, a friction braking system comprising a plurality of friction brakes, where each friction brake is coupled to a respective wheel on each of the primary and auxiliary axles, and a controller. The controller includes computer-readable instructions for: in response to a deceleration request and predetermined vehicle operating conditions for operation in a tire life mode being met, actuating a first portion of the friction brakes to apply a first brake torque to the auxiliary axles and actuating the electric motor and a second portion of the friction brakes to apply a remaining, second brake torque to the primary axles. The first brake torque is greater than the second brake torque.

### CROSS-REFERENCE

This application claims priority to U.S. Provisional Application No. 63/739,813, filed Dec. 30, 2024, which is hereby incorporated by reference herein in its entirety.

### FIELD

This disclosure generally relates to systems and methods for operating a powertrain and braking system of a vehicle.

### BACKGROUND

A vehicle can include a chassis with a plurality of axles including primary axles and auxiliary axles. Primary axles can include steer and/or drive axles, and auxiliary axles are non-driven axles that only support a load of the vehicle. For example, auxiliary axles can be arranged on a trailer of the vehicle. In some examples, the primary axles include one or more drive axles that are driven by an electric motor. In such instances, the vehicle system can employ friction brakes (which can also be referred to as service brakes) on all the primary and auxiliary axles to slow the vehicle in response to a deceleration request. The vehicle system can also employ recuperative braking (which can also be referred to as regenerative braking) on the primary drive axles to provide additional brake torque to slow the vehicle.

### SUMMARY

In some aspects, the techniques described herein relate to a vehicle system including: a vehicle chassis including one or more primary axles and one or more auxiliary axles; a powertrain including at least one electric motor coupled to the one or more primary axles; a friction braking system including a plurality of friction brakes, wherein each friction brake is coupled to a respective wheel on each of the one or more primary axles and the one or more auxiliary axles; and a controller including a non-transitory storage medium with computer-readable instructions for: in response to a deceleration request and predetermined vehicle operating conditions for operation in a first braking mode being met, actuating a first portion of the plurality of friction brakes to apply a first brake torque to at least one of the one or more auxiliary axles and actuating the at least one electric motor and a second portion of the plurality of friction brakes to apply a remaining, second brake torque to the one or more primary axles, wherein the first brake torque is greater than the second brake torque, and wherein the first and second brake torque equal a total brake torque request for the deceleration request.

In some aspects, the techniques described herein relate to a method including: responsive to a deceleration request received at a controller of a vehicle and a first set of vehicle operating conditions being met: determining an auxiliary brake bias factor based on a second set of vehicle operating conditions, wherein the vehicle includes one or more primary axles that are driven by one or more electric motors of the vehicle and one or more auxiliary axles that are non-driven axles of the vehicle; determining a primary brake torque request and an auxiliary brake torque request based on a total brake torque request that is based on the deceleration request, and the auxiliary brake bias factor, wherein the auxiliary brake torque request is greater than the primary brake torque request; actuating a friction braking system of the vehicle to apply friction brakes on the one or more auxiliary axles to deliver the auxiliary brake torque request evenly across the friction brakes on the one or more auxiliary axles; actuating the one or more electric motors to deliver a first amount of the primary brake torque request as recuperative brake torque to the one or more primary axles, wherein the first amount is equal to an available amount of the recuperative brake torque; and actuating the friction braking system to apply the friction brakes on the one or more primary axles to deliver a remaining amount of the primary brake torque request.

In some aspects, the techniques described herein relate to a controller of a vehicle system, including: at least one memory; and at least one processor couples with the at least one memory and configured to: in response to a deceleration request when predetermined operating conditions of the vehicle system for operating in a first braking mode are present, operating in the first braking mode by actuating brake valves of a friction braking system of the vehicle system and one or more electric motors of a powertrain of the vehicle system so that a majority of a total brake torque request that is determined based on the deceleration request is applied to non-driven, auxiliary axles of the vehicle system and a remainder of the total brake torque request is applied to primary axles of the vehicle system, and wherein a first portion of the remainder of the total brake torque request applied to the primary axles is recuperative brake torque applied by the one or more electric motors and a second portion of the remainder of the total brake torque request applied to the primary axles is friction brake torque applied by the brake valves; and in response to the deceleration request when the predetermined operating conditions for operating in the first braking mode are not present, operating in a second braking mode by actuating the brake valves of the friction braking system and the one or more electric motors of the powertrain of the vehicle system so that a total brake torque request determined based on the deceleration request is applied evenly across all known axles as a primary brake torque request to the primary axles and an auxiliary brake torque request to the auxiliary axles, and wherein the first portion of the primary brake torque request applied to the primary axles is the recuperative brake torque applied by the one or more electric motors and the second portion of the primary brake torque request applied to the primary axles is the friction brake torque applied by the brake valves. The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a schematic diagram of an exemplary vehicle system comprising one or more primary axles and one or more auxiliary axles.

FIG. 2A is a schematic of an exemplary vehicle comprising one primary axle and one auxiliary axle.

FIG. 2B is a schematic of an exemplary vehicle comprising primary axles that include a steer axle and drive axle on a tractor of the vehicle, and auxiliary axles on a trailer of the vehicle.

FIG. 2C is a schematic of an exemplary vehicle comprising primary axles that include a steer axle and drive axle and auxiliary axles that include lift axles.

FIG. 2D is a schematic of an exemplary vehicle comprising primary axles that include a steer axle and drive axle and auxiliary axles that include tag axles and lift axles.

FIG. 3 is a schematic diagram of an exemplary braking system of the vehicle system of FIG. 1.

FIG. 4 is a flow chart of a method for distributing a brake torque request between primary and auxiliary axles of the vehicle system such that most of the brake torque request is directed to the auxiliary axles, when predetermined operating conditions are met.

FIG. 5 is a flow chart of a method for distributing a brake torque request between primary and auxiliary axles of the vehicle such that the brake torque request is distributed evenly between the primary axles and the auxiliary axles, when the predetermined conditions are not met.

FIG. 6 is a schematic diagram illustrating an example of operating the vehicle system in a standard braking mode during a deceleration request.

FIG. 7 is a schematic diagram illustration an example of operating the vehicle system in a tire life mode during a deceleration request.

### DETAILED DESCRIPTION

As introduced above, a vehicle can include a plurality of axles, including one or more primary axles and one or more auxiliary axles. As used herein, primary axles include axles that are driven (referred to a driven or drive axles) by a propulsion system of the vehicle (e.g., an electric motor) and/or axles that are used to steer the vehicle (referred to as steer axles). As such, primary axles of a vehicle can include primary drive axles, primary steer axles, or combinations thereof. Auxiliary axles include non-driven axles (i.e., axles that do not provide drive torque to the vehicle) that are configured to support a load of the vehicle but not provide torque or steer the vehicle. As described further herein, examples of such auxiliary axles can include axles on a trailer of a combination tractor-trailer vehicle, lift axles that are lifted and configured to carry loads over a threshold, and pusher or tag axles that are only configured to carry loads.

Battery electric vehicles can comprise a propulsion or powertrain system comprising one or more electric motors coupled to the drive axles (included in the primary axles) of the vehicle. In some examples, such vehicle systems can employ recuperative braking (which can also be referred to as regenerative braking) where brake torque is applied to the drive axles with the motors and the resulting braking energy is recuperated and stored for future use. Recuperative braking can increase an efficiency of the vehicle by increasing the vehicle's range.

However, such recuperative braking efforts can increase wear on the tires on the electrically driven axles, thereby reducing a longevity of the driven tires on the drive axles. For example, because electric vehicle range is usually desired in electric vehicles, recuperative braking is prioritized and thus, is used more often (as compared to engine braking in diesel or internal combustion engines, for example). Since there is a greater control region (torque and speed) for electric recuperative braking, recuperative braking can be used at higher magnitudes of torque at all speed ranges, thereby increasing the wear on the driven tires. The driven tires can be more expensive than the tires on the auxiliary axles. Thus, recuperative braking can also increase vehicle costs if the driven tires must be replaced often due to wear.

To address these issues, a vehicle system can employ a vehicle control mode that is configured to prioritize or redistribute brake torque to auxiliary axles during a deceleration or braking event. As a result, a greater proportion of the total torque requested to slow the vehicle (based on the deceleration request) can be applied via friction brakes on the auxiliary axles, while a smaller proportion of the brake torque is delivered to the primary axles. The brake torque applied to the primary axles can be split between recuperative brake torque on the drive axles and friction brake torque on the drive and/or steer axles. Such a vehicle control mode can be referred to herein as a “tire life mode” and may only be executed when predetermined vehicle operating (which may include select environmental or road conditions) are met. If such conditions are not met, the vehicle can operate in a “standard” or “non-biassed” control mode where the auxiliary axles are not prioritized over the primary axles.

Further, for instance in an example implementation, the vehicle control mode includes a braking mode that is purpose-built to extend tire life and reduce ownership cost while maintaining braking performance and stability by systematically shifting a greater fraction of braking work to auxiliary axles under high-stability conditions (e.g., straight-line, moderate deceleration, adequate adhesion), thereby lowering thermal and mechanical loads- and thus wear and temperature cycling-on steer and drive tires; at all times, the sum of auxiliary and primary axle braking equals the total brake torque requested for the deceleration command and is verified in closed loop. Within this allocation, regenerative and friction braking are coordinated to preserve energy recovery and avoid adverse interactions: available regenerative torque on the primary axles is prioritized to cut heat and lining wear, while a greater auxiliary friction contribution satisfies the tire-life objective because auxiliary axles typically have more longitudinal slip margin and are less sensitive to wear-driven handling effects. The strategy is safeguarded by slip detection and anti-lock intervention logic that, when traction limits are approached, automatically reduces the auxiliary bias and/or exits the braking mode to preserve stability and controllability.

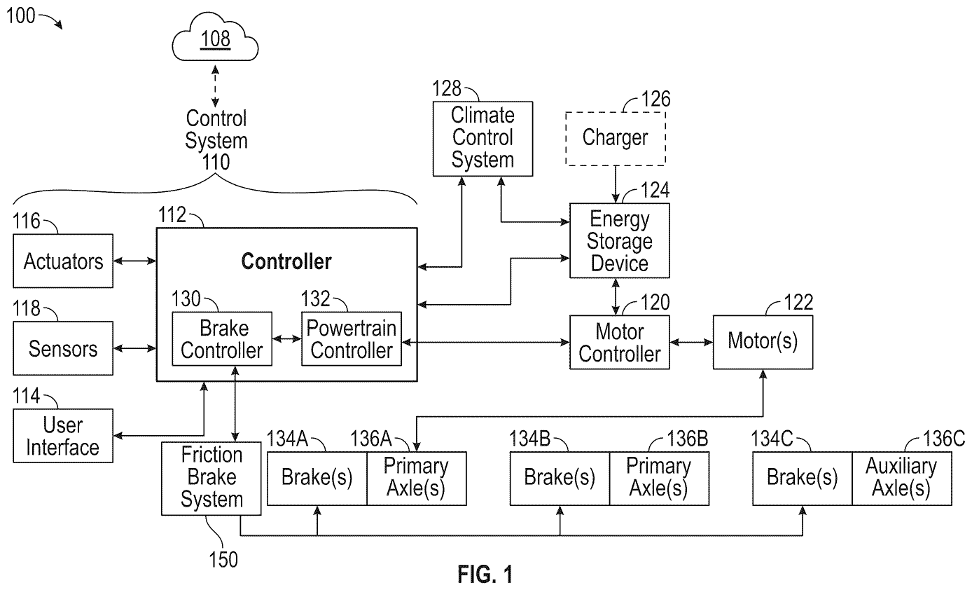

FIG. 1 is a system diagram of an exemplary vehicle system comprising primary axles and one or more auxiliary axles. The vehicle system can be a battery electric vehicle comprising one or more motors configured to provide torque to (i.e., drive) one or more of the primary axles. The vehicle system can also include a braking system comprising one or more friction brakes on a wheel of each axle.

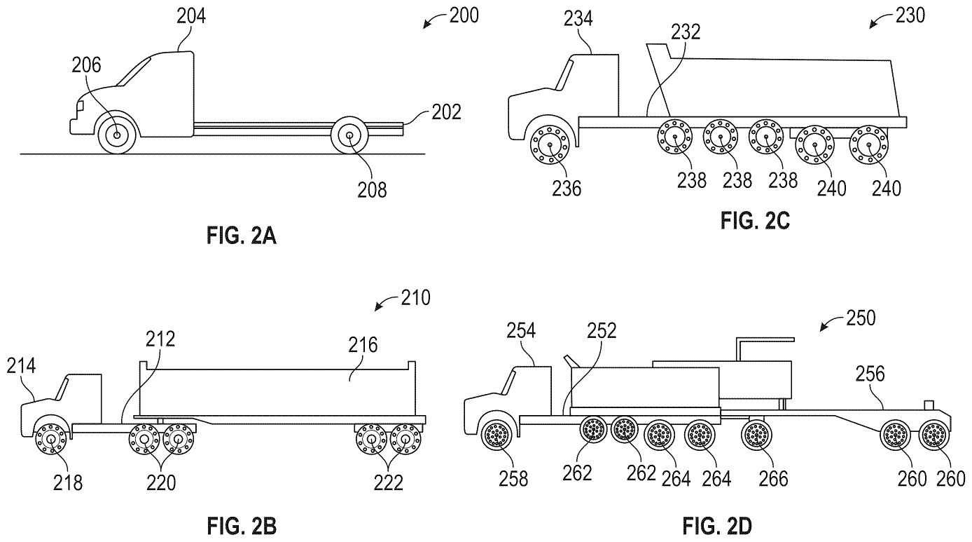

In some examples, the vehicle system of FIG. 1 can be included in a variety of vehicles, such as any of the combination or rigid vehicles shown in FIGS. 2A-2D. As shown in FIGS. 2A-2D, the vehicles can include one or more auxiliary axles.

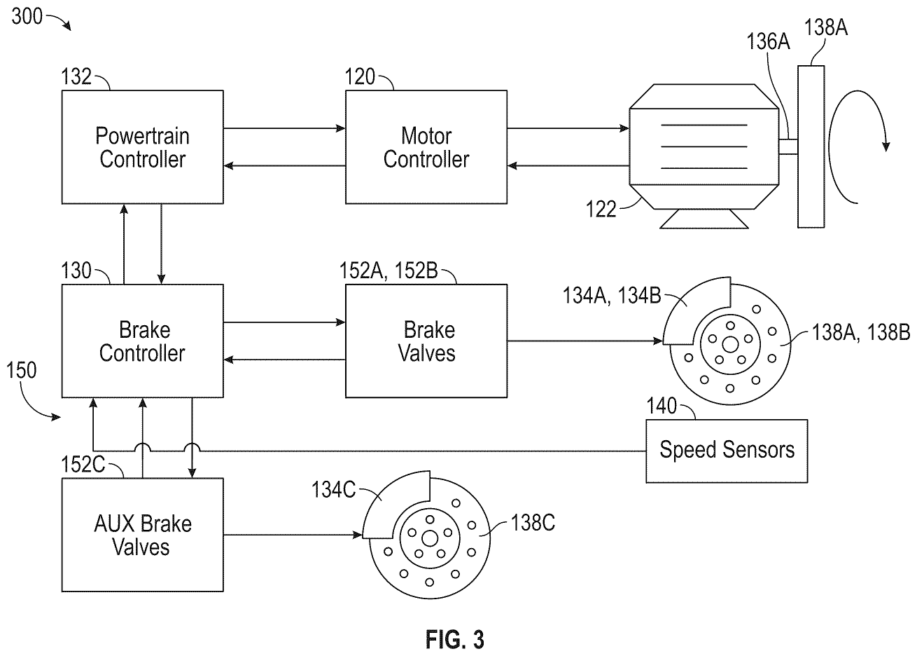

FIG. 3 is a diagram of an exemplary control system for the powertrain and braking systems of the vehicle. In some examples, the vehicle control system can comprise a powertrain controller that is configured to actuate one or more electric motors for providing torque or recuperative braking, and a brake controller that is configured to actuate a plurality of brake valves. In this way, in some examples, all the axles of the vehicle can comprise friction brakes and one or more primary axles (e.g., the drive axles) can be coupled to a motor for recuperative braking.

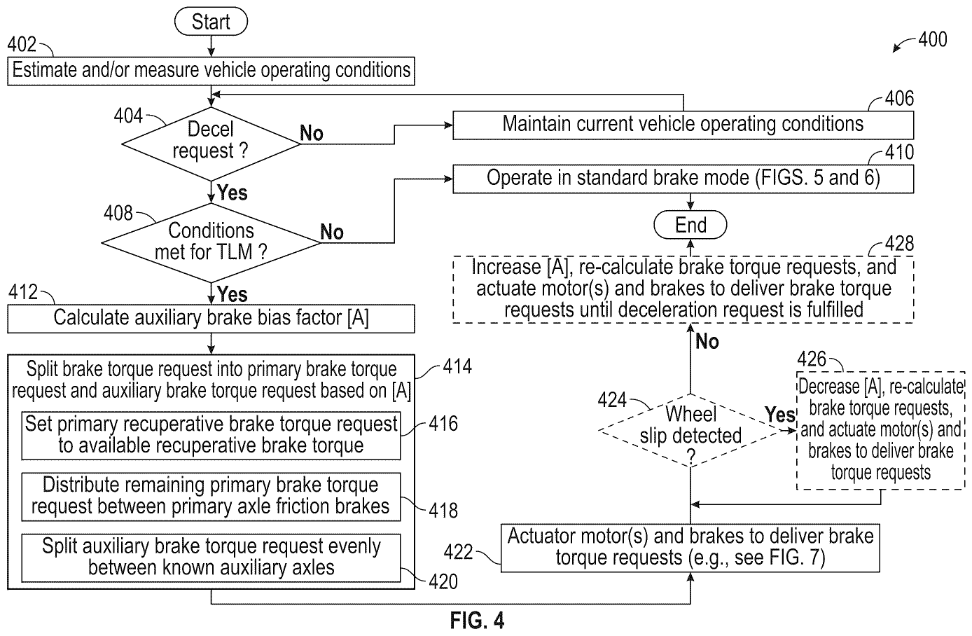

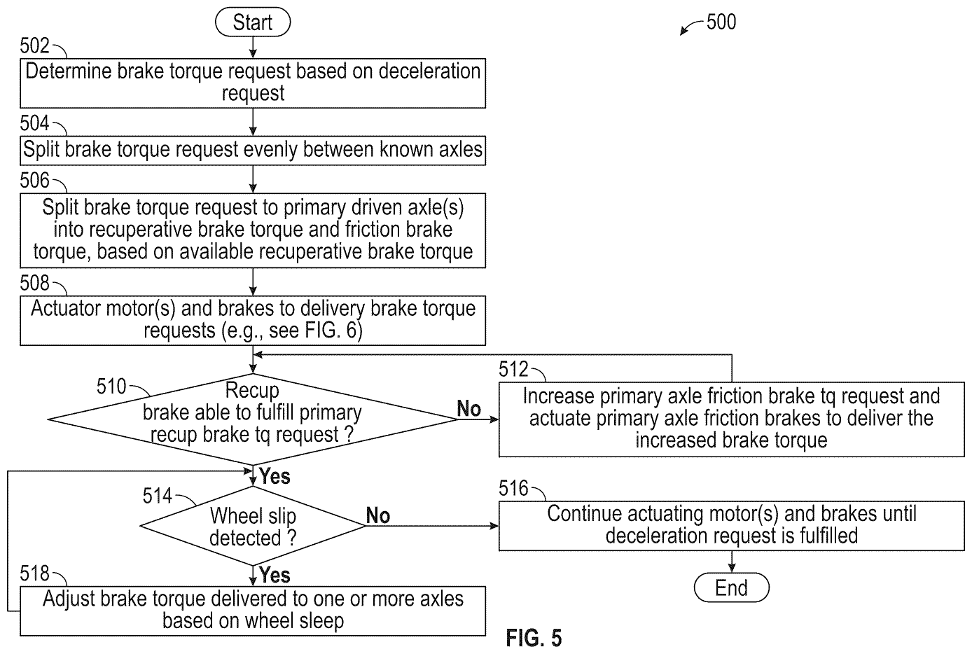

During vehicle operation, the vehicle controller can receive a deceleration request. If predetermined operating conditions are met, a tire life mode can be executed where the requested brake torque is redistributed such that a majority is applied to the auxiliary axles, as shown in the method of FIG. 4. If the predetermined operating conditions for the tire life mode are not met, the method can proceed to operate the vehicle in a standard brake mode, as shown in FIG. 5. In this way, during select braking events, when the tire life mode is selected or activated, more brake torque can be applied to the auxiliary axles than the primary axles, thereby increasing a longevity of the tires on the primary drive axles.

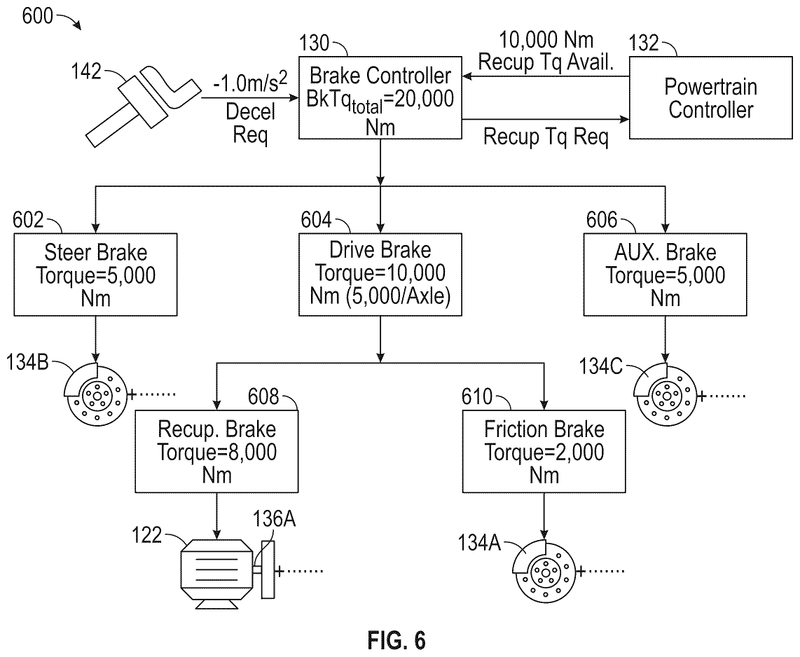

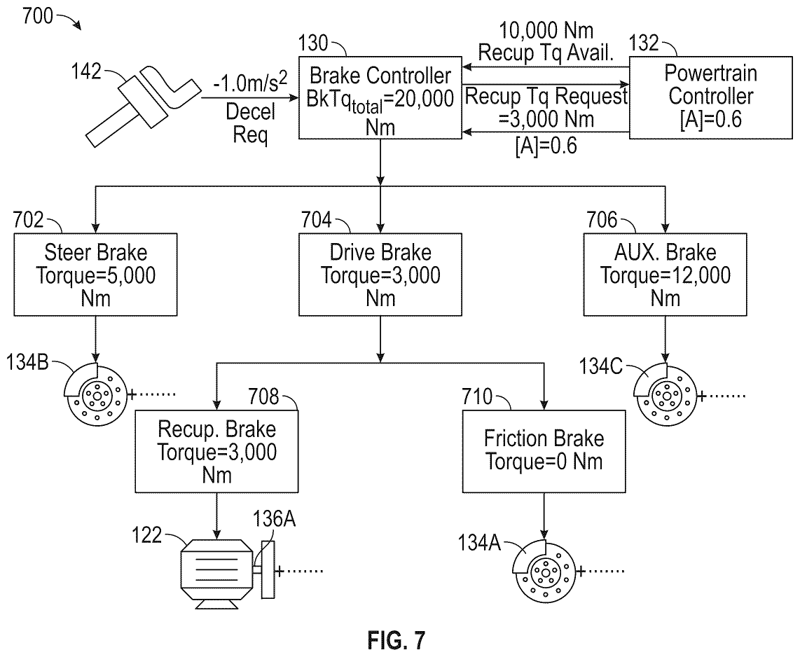

FIGS. 6 and 7 present examples of operations in the standard brake mode (FIG. 6) and the tire life mode (FIG. 7) for a same total brake torque request. As shown in these flow charts, a larger amount of brake torque is applied to the auxiliary axles in the tire life mode than in the standard brake load, thereby allowing less brake torque to be applied to the primary drive axles in the tire life mode. As a result, the tires of the primary axles can experience reduced wear, thereby increasing their longevity and reducing vehicle costs.

### Examples of the Disclosed Technology

FIG. 1 depicts a vehicle system 100 for a vehicle. The vehicle system 100 can be included in a variety of vehicles, such as any of the vehicle shown in FIGS. 2A-2D, as described further below. The vehicle system 100 includes a vehicle chassis with one or more primary axles 136A, 136B and one or more auxiliary axles 136C. In the example of FIG. 1, the primary axles(s) 136A are drive axles that are driven by a propulsion system of the vehicle (e.g., motor 122) and provide torque to the vehicle system 100. The vehicle system 100 further includes at least one primary axle 136B that is a steer axle. The steer axle(s) is configured to steer the vehicle, but not provide drive torque. In some examples, the steer axle (primary axle 136B) may be driven (for example, in the case of an all-wheel drive vehicle). In such cases, the motor 122 of the vehicle system 100 can be coupled and configured to provide torque to the primary axle(s) 136B (steer axle(s) (or the steer axle(s) may be included in the primary axle(s) 136A and the vehicle system 100 may not include primary axle(s) 136B).

The vehicle system 100 also includes one or more auxiliary axles 136C that do not provide drive torque to the vehicle (which can be referred to as “non-driven axles”) and instead are configured to support a load of the vehicle. As described further below with reference to FIGS. 2A-2D, examples of such auxiliary axles 136C can include axles on a trailer of a combination tractor-trailer vehicle, lift axles that are lifted and configured to carry loads over a threshold, and pusher or tag axles that are only configured to carry loads.

In some examples, as depicted in FIG. 1, the vehicle system 100 is a battery electric vehicle (BEV), which is an all-electric vehicle propelled by one or more electric motors 122 without assistance from an internal combustion engine (not shown). The motor 122 receives electrical power and provides drive torque for vehicle propulsion. The motor 122 also functions as a generator for converting mechanical power into electrical power through recuperative braking (which can also be referred to as regenerative braking). As such, the motor(s) 122 can provide brake torque to the driven, primary axle(s) 136A.

The powertrain of the vehicle system 100 includes the one or more motors 122 and a motor controller 120 which controls the motor(s) 122 to deliver torque (for example, the motor controller 120 can adjust the drive torque and speed of the motor 122). The motor(s) 122 delivers drive torque to one or more primary axles 136A (which therefore can be referred to a driven primary axles 136A) of the vehicle system 100, thereby transmitting toque to one or more pairs of driven wheels 138A (as shown in FIG. 3, which is described in more detail below).

Although illustrated and described in the context of a BEV, it is understood that aspects of the present application may be implemented on other types of electric vehicles, such as those powered by an internal combustion engine in addition to one or more electric machines (e.g., hybrid electric vehicles (HEVs), full hybrid electric vehicles (FHEVs) and plug-in electric vehicles (PHEVs), etc.), or fuel cell electric vehicles (FCEVs).

The vehicle system 100 includes a control system 110 including a controller 112 (which can be referred to as a vehicle controller 112), a plurality of actuators 116, a plurality of sensors 118, and a user interface 114 that are all in communication with each other. The controller 112 may further include a wireless communication device to enable wireless communication between the vehicle and other vehicles or infrastructures, via a wireless network 108.

The controller 112 receives input signals, such as a deceleration request through a brake pedal (or a brake pedal position sensor of the brake pedal) and controls the vehicle system 100 via a brake controller 130 and powertrain controller 132 to deliver the brake torque to decelerate the vehicle according to the deceleration request. As described further herein, the controller 112 can operate the vehicle system 100 in different braking modes based on the received input signals.

The vehicle system 100 includes an energy storage device 124 for storing electrical energy. The motor(s) 122 is electrically coupled to the energy storage device 124 through a motor controller 120. In some examples, the energy storage device 124 includes a battery (which may comprise one or more battery modules) that is capable of outputting electrical power to operate the motor(s) 122. The energy storage device 124 also receives electrical power from the motor(s) 122, when the motor(s) 122 is operating as a generator during recuperative braking.

In some examples, the motor controller 120 acts as an inverter that converts the direct current (DC) power supplied by the energy storage device 124 to alternating current (AC) power for operating the motor(s) 122. In such cases, the motor controller 120 also converts alternating current (AC) provided by the motor(s) 122, when acting as a generator, to DC for charging the energy storage device 124.

In some examples, the motor(s) 122 is a DC driven motor. In such cases, the motor controller 120 can control the motor(s) 122, for example by pulsing direct current to the motor(s) 122.

In some examples, the energy storage device 124 includes an electronic monitoring system that manages temperature and state of charge of each battery cell of the battery of the energy storage device 124.

Other examples of the vehicle system 100 may comprise different types of energy storage systems, such as capacitors and fuel cells. Thus, in some examples, the energy storage device 124 can comprise one or more fuel cells or capacitors.

The powertrain of the vehicle system 100 includes a powertrain controller 132 for controlling the motor(s) 122 and the motor controller 120. The powertrain controller 132 monitors, among other things, the position, speed, and power consumption of the motor(s) 122 and provides output signals corresponding to this information to other vehicle systems. In some examples, the powertrain controller 132 and the motor controller 120 convert the direct current (DC) voltage supply by the energy storage device 124 into alternating current (AC) signals that are used to control the motor(s) 122.

The vehicle controller 112 communicates with other vehicle systems and controllers for coordinating their function, such as the brake controller 130 and the powertrain controller 132. The vehicle controller 112 may include the depicted controllers, as well as additional controllers, that may be used to control multiple vehicle systems according to an overall vehicle system control (VSC) logic, or software. For example, the powertrain controller 132 may be a powertrain control module (PCM) having a portion of the VSC software embedded therein. The vehicle controller 112 generally includes any number of microprocessors, ASICs, ICs, memory (e.g., FLASH, ROM, RAM, EPROM and/or EEPROM) and software code to co-act with one another to perform a series of operations. The memory of the controller 112 can include non-transitory memory for storing instructions for executing the vehicle system methods described herein. The vehicle controller 112 also includes predetermined data, or “look up tables” that are based on calculations and test data and stored within the memory. The vehicle controller 112 communicates with other controllers over a hardline vehicle connection using a common bus protocol (e.g., CAN).

The user interface 114 communicates with the vehicle controller 112 for receiving information regarding the vehicle and its surroundings and conveys this information to the driver. The user interface 114 includes a number of interfaces, such as gauges, indicators, and displays. The user interface 114 may also include a controller for communicating with the vehicle controller 112 and external devices, such as a computer or cellular phone. The vehicle controller 112 provides output to the user interface 114, such as a status of the motor(s) 122 or energy storage device 124, which is conveyed visually to the driver.

In some examples, the user interface 114 can include various input portions for receiving an operator input, such as buttons, one or more touch screens, a microphone for voice input/recognition, and/or the like. For example, an operator of the vehicle (“the user” or “operator”) can provide voice or touch input via the user interface 114 for activating various modes of the vehicle, such as a tire life mode, as described further herein.

The vehicle system 100 includes a climate control system 128 for heating and cooling various vehicle components and a cab or passenger compartment of the vehicle. The climate control system 128 can include various combinations of components, such as heaters, compressors, and/or the like. The climate control system 128 can draw electrical energy directly from the energy storage device 124. The climate control system 128 can include a climate controller for communicating with the vehicle controller 112. In some examples, the climate control system 128 is configured to control a temperature of the energy storage device 124.

In some examples, the vehicle system 100 includes a DC or AC charger 126 for charging the energy storage device 124. For example, in some instances, an electrical connector can connect the charger 126 to an external power supply for receiving AC power. The charger 126 can include power electronics used to invert, or “rectify” the AC power received from the external power supply to DC power for charging the energy storage device 124.

The charger 126 can be configured to accommodate one or more conventional voltage sources from the external power supply (e.g., 110 volt, 220 volt, etc.). The external power supply may include a device that harnesses renewable energy, such as a photovoltaic (PV) solar panel, or a wind turbine (not shown).

In some examples, the vehicle system 100 may not include the charger 126. For example, if the energy storage device 124 comprises one or more fuel cells, the vehicle system 100 may not need the charger 126.

Also shown in FIG. 1 are simplified schematic representations of vehicle sensors 118 and actuators 116 used throughout the vehicle system 100. Examples of vehicle sensors 118 can include a battery state of charge sensor (for the energy storage device 124), various temperature sensors (including ambient air temperature sensors, brake temperature sensors, energy storage device or battery temperature, and the like), vehicle speed sensors, an accelerator pedal sensor (for determining pedal position information to determine driver request for drive torque), a brake pedal sensor (for determining pedal position information to determine driver deceleration request and a corresponding brake torque request), an accelerometer sensor, a steering sensor, wheel speed sensors, pressure sensors, and the like. Examples of vehicle actuators 116 can include actuators for the motor controller 120, motor(s) 122, heaters, fans, brake valves of a friction braking system 150, and the like.

The controller 112 may receive input data from the various sensors 118, process the input data, and trigger the actuators 116 in response to the processed input data based on instruction or code programmed therein corresponding to one or more routines. Example control routines are described herein with reference to FIGS. 4 and 5.

The vehicle system 100 includes a brake system which includes a brake pedal 142 (shown in FIGS. 6 and 7), the brake controller 130, and a friction brake system 150 including brake valves 152A-152C (depicted in FIG. 3) connected to friction brakes 134A, 134B, 134C at the vehicle wheels to effect friction braking. In some examples, friction brakes can be referred to as “service brakes.”

In some examples, as shown in FIG. 1, the friction braking system 150 is an electronic braking system (EBS) which combines pneumatic braking components (pneumatic valves) with electrical control to precisely and quickly activate the brakes. For example, an electronic braking system can comprise a compressor to generate compressed air, air reservoirs, solenoid valves controlled by electrical signals (e.g., pneumatic brake valves 152A-152C), brake chambers to convert air pressure into mechanical force, the brake controller 130 to manage braking pressure, and the mechanical braking components, such as brake shoes or discs and calipers (which can be referred to herein collectively as “brakes” 134A, 134B, 134C). When the brake pedal is pressed, an electrical signal is sent to the controller 112 and a brake torque request is determined. As explained in greater detail herein, depending on the braking mode, a friction brake torque request for one or more of the vehicle axles is determined and sent to the friction braking system 150 by the brake controller 130. For example, activation signals are sent to the specified brake valves 152A-152C to allow compressed air to flow to the brake chambers, which thereby activates the brakes 134A, 134B, 134C.

By utilizing an EBS as the friction braking system 150, the friction braking system 150 can provide smoother braking and improved balance across different load conditions for the vehicle system 100 (as opposed to vehicles systems that do not have an EBS friction braking system). Additionally, the EBS can provide quicker response times for activating the brake valves and brakes. This can allow for more fine-tuned braking control, as discussed herein with reference to the routines presented at FIGS. 4 and 5.

However, in some examples, the friction braking system 150 is another type of braking system, such as an anti-lock braking system (ABS), a hydraulic braking system, or the like. Such systems can be controlled according to the routines described herein.

The brake controller 130, powertrain controller 132, friction braking system 150, motor controller 120, and motor(s) 122 make up a braking system 300 of the vehicle system 100, which is depicted schematically in FIG. 3. The braking system 300 also includes a variety of position sensors, pressure sensors, wheel speed sensors (speed sensors 140 depicted in FIG. 3), vehicle speed sensors, an accelerometer sensor, temperature sensors, battery state of charge sensors, and/or the like, for providing information such as brake pedal position, actual brake torque, wheel speed, wheel slip, and the like, that can be used by the brake controller 130 and powertrain controller 132 to determine brake torque requests and whether certain braking modes (such as a tire life mode, as described further below) can be enabled.

As depicted in FIG. 3, the brake controller 130 and the powertrain controller 132 communicate with one another to coordinate friction braking and recuperative braking. The brake controller 130 receives an input signal that corresponds to a deceleration request. The input signal may be one or more of an accelerator pedal position and a brake pedal position (of a brake pedal 142, as depicted in FIGS. 6 and 7). The brake controller 130 provides an input signal to the powertrain controller 132 that corresponds to a total brake torque value (or brake torque request), which can be determined based on the deceleration request. The powertrain controller 132 then compares the total brake torque value to other information to determine a recuperative braking torque value and a friction braking torque value, where the sum of the recuperative braking torque value and the friction braking torque value is approximately equal to the total brake torque value. The powertrain controller 132 provides the recuperative braking torque value to the motor controller 120, which in turn controls the motor(s) 122 to provide recuperative braking. The brake controller 130 provides the friction braking torque value to the friction brake system 150, which in turn controls the brake valves 152A-152C to provide friction braking via the friction brakes 134A, 134B, 134C.

As shown in FIG. 3, the vehicle system 100 can include one or more primary axles 136A that are drive axles (torque provided by the motor(s) 122), and thus drive the driven wheels 138A. The driven wheels 138A also have friction brakes 134A. Thus, the primary axles 136A can be decelerated or braked via recuperative braking, friction braking, or a combination thereof. The vehicle system 100 can include one or more primary axles 136B that are steer axles. The steer wheels 138B of the one or more primary axles 136B comprise friction brakes 134B. The vehicle system 100 also includes one or more auxiliary axles with auxiliary wheels 138C. The auxiliary wheels 138C have friction brakes 134C.

In some examples, upon receipt of a deceleration request (e.g., brake pedal position of brake pedal 142 or commanded deceleration), and after confirming predetermined conditions for a first braking mode (e.g., a tire life mode), the brake controller 130 allocates a total brake torque value so as to preferentially utilize auxiliary-axle friction brakes 134C. To do so, the brake controller 130 (in communication with the powertrain controller 132) determines (i) a recuperative braking torque value available from the motor(s) 122 and (ii) a friction braking torque value to be provided by the friction braking system 150, and apportions the friction braking torque value into a first braking torque applied to one or more auxiliary axles with auxiliary wheels 138C and a remaining, second braking torque applied to one or more primary axles 136A, 136B, with the constraint that the first braking torque is greater than the second braking torque and that the sum of the recuperative braking torque value and the friction braking torque value is approximately equal to the total brake torque value. When the first braking mode is enabled, the brake controller 130 computes the auxiliary/primary split using inputs that can include any combination of the deceleration request, vehicle speed, steering angle, lateral and longitudinal acceleration, brake pedal position, wheel speeds from speed sensors 140, available recuperative torque from the powertrain controller 132, brake temperatures, ambient temperature, axle load estimates, and mode-enable signals. The brake controller 130 then issues auxiliary torque commands to the friction braking system 150 to actuate selected brake valves 152A-152C so as to apply the first braking torque to the auxiliary friction brakes 134C, and apportions the remaining second braking torque to the primary-axle friction brakes 134A, 134B after accounting for the available recuperative braking commanded by the powertrain controller 132 to the motor controller 120 and motor(s) 122. Correspondingly, the friction braking system 150 employs closed-loop pressure control to track commanded torque using wheel-speed feedback (and optionally pressure or torque estimation), while the recuperative braking command is bounded by instantaneous motor, inverter, and battery capability and traction limits inferred from wheel-slip estimates. In an aspect, any shortfall in recuperative capability is backfilled by increasing the primary-axle friction braking so that the sum of the first and second braking torques and the recuperative braking torque value remains approximately equal to the total brake torque value.

As described further herein with reference to FIGS. 4-7, the total brake torque request can be split between the primary axles 136A, 136B and the auxiliary axles 136C based on a selected or specified braking mode of the vehicle. As a result, during predetermined operating conditions, total brake torque may be redistributed such that a majority of the brake torque request is applied to the auxiliary axles 136C rather than the primary axles 136A, 136B (referred to herein as a “tire life mode” or “tire life braking mode”). In contrast, when the predetermined operating conditions are not met, total brake torque may be distributed such that brake torque request is split evenly between the known axles (primary and auxiliary), which can result in a greater amount of recuperative braking to be applied to the driven primary axle(s) 136A than when operating in the tire life mode.

The vehicle system 100 can comprise various combinations of primary axles and auxiliary axles. Exemplary vehicles, which can include the vehicle system 100, having different arrangements and types of primary and auxiliary axles are depicted in FIGS. 2A-2D.

FIG. 2A depicts a vehicle 200 comprising a chassis 202, a cab 204, a front axle 206, and a rear axle 208. The front axle 206 is a drive axle and a steer axle (for example, the front axle 206 is a steer axle that receives drive torque, such as from the electric motor 122), and thus can be a primary axle 136A in the vehicle system 100. The rear axle 208 is a non-driven axle and thus can be an auxiliary axle 136C in the vehicle system 100. In some examples, the vehicle 200 is a rigid commercial vehicle, such as a flatbed truck, pickup truck, a towing vehicle, or the like. In some examples, the vehicle 200 is a front-wheel drive vehicle.

FIG. 2B depicts a vehicle 210 comprising a chassis 212, a cab 214, a trailer 216, a steer axle 218, drive axles 220, and trailer axles 222. The drive axles 220 are driven axles (receives drive torque, such as from the electric motor 122), and thus can be primary axles 136A in the vehicle system 100. The steer axle 218 is configured to steer to the vehicle, and in some examples can be driven when the vehicle 210 is all-wheel drive. The steer axle 218 can be the primary axle 136B in the vehicle system 100. The trailer axles 222 are non-driven axles and thus can be an auxiliary axles 136C in the vehicle system 100. Although the vehicle 210 includes two drive axles 220 and two trailer axles 222, in some examples the vehicle can include more or less than two drive axles 220 and/or more or less than two trailer axles 222 (such as one, three, four, or the like). In some examples, the vehicle 210 is a combination vehicle, such as a tractor trailer vehicle.

FIG. 2C depicts a vehicle 230 comprising a chassis 232, a cab 234, a steer axle 236, lift axles 238, and drive axles 240. The chassis 232 is a rigid chassis 232 with a load arranged on the chassis 232 behind the cab 234. The drive axles 240 are driven axles (receives drive torque, such as from the electric motor 122), and thus can be primary axles 136A in the vehicle system 100. The steer axle 236 is configured to steer to the vehicle, and in some examples can be driven when the vehicle 230 is all-wheel drive. The steer axle 236 can be the primary axle 136B in the vehicle system 100. The lift axles 238 are non-driven axles that can be lifted and only carry loads above a threshold. Thus, the lift axles 238 can be auxiliary axles 136C in the vehicle system 100. Although the vehicle 230 includes two drive axles 240 and three lift axles 238, in some examples the vehicle can include more or less than two drive axles 240 and/or more or less than three lift axles 238 (such as one, two, three, four, or the like). In some examples, the vehicle 230 is a rigid vehicle, such as a dump truck.

FIG. 2D depicts a vehicle 250 comprising a chassis 252, a cab 254, a trailer 256, a steer axle 258, lift axles 262, drive axles 264, a tag axle 266, and trailer axles 260. The chassis 252 is a rigid chassis 252 with a load arranged on the chassis 252 behind the cab 254. The trailer 256 is attached behind the chassis 252. The drive axles 264 are driven axles (receives drive torque, such as from the electric motor 122), and thus can be primary axles 136A in the vehicle system 100. The steer axle 258 is configured to steer to the vehicle, and in some examples can be driven when the vehicle 230 is all-wheel drive. The steer axle 258 can be the primary axle 136B in the vehicle system 100. The lift axles 262 are non-driven axles that can be lifted and only carry loads above a threshold. The trailer axles 260 and tag axle 266, which is contact with the road but only carries load, are also non-driven axles. Thus, the lift axles 262, trailer axles 260, and tag axle 266 can all be auxiliary axles 136C in the vehicle system 100. Although the vehicle 250 is depicted with two drive axles 264, two lift axles 262, one tag axle 266, and two trailer axles 260, in some examples the vehicle can include more or less than these number of axles (such as one, two, three, four, or the like). In some examples, the vehicle 250 is a combination vehicle, such as a rigid truck with a trailer.

As introduced above, recuperative braking recharges the energy storage device 124 and recovers much of the energy that would otherwise be lost as heat during friction braking. Therefore, recuperative braking improves the overall efficiency or range of the vehicle as compared to vehicles that are only configured for friction braking. However, recuperative braking efforts can increase wear on the tires of the electrically driven axles, thereby reducing a longevity of the driven tires. Since the driven tires are usually more expensive than the tires on the auxiliary axles, this can increase vehicle system costs. In some examples, the steer tires of the steer axles can be more expensive that the tires on the auxiliary axles as well.

To address these issues, a vehicle system, such as the vehicle system 100, can employ a vehicle control mode that is configured to redistribute brake torque to auxiliary axles (and away from the primary axles) during a deceleration or braking event. As a result, a greater proportion of the total torque requested to slow the vehicle (based on the deceleration request) can be applied via friction brakes to the auxiliary axles, while a smaller proportion of the brake torque is delivered to the primary axles. The brake torque applied to the primary axles can be split between recuperative brake torque on the drive axles and friction brake torque on the drive and/or steer axles. Such a vehicle control mode can be referred to herein as a “tire life mode” or a “tire life braking mode” and may only be executed when predetermined vehicle operating and/or environmental conditions are met. In some examples, a user or vehicle operator can manually request (for example, via the user interface 114) operation in the tire life mode. If such conditions are not met, the vehicle can operate in a “standard” or “non-biassed” braking control mode where the auxiliary axles are not prioritized over the primary axles (for example, brake torque may be distributed evenly across all known vehicle axles).

FIGS. 4 and 5 present methods for determining and distributing a brake torque request between primary and auxiliary axles of a vehicle. Specifically, FIG. 4 presents a method 400 for distributing a brake torque request between primary and auxiliary axles of the vehicle such that most of the brake torque request is directed to the auxiliary axles, when predetermined operating conditions are met. This can be referred to herein as a “tire life mode” since by biasing brake torque to the auxiliary axles over the primary axles (or drive axles), the longevity or lifetime of the driven tires (and/or the steer tires) of the primary axles can be increased (thereby decreasing vehicle costs). FIG. 5 presents a method 500 for distributing a brake torque request between primary and auxiliary axles of the vehicle such that the brake torque request is distributed evenly (or more evenly than in the tire life mode) between the primary axles and the auxiliary axles, when the predetermined conditions are not met.

Methods 400 and 500 will be described with reference to the systems described herein and shown in FIGS. 1-3, though it should be understood that similar methods may be applied to other systems without departing from the scope of this disclosure. Methods 400 and 500 may be carried out by a controller, such as the controller 112 in FIG. 1 (and/or the brake controller 130 and powertrain controller 132 depicted in FIGS. 1 and 3), and may be stored at the controller as executable instructions in non-transitory memory. Instructions for carrying out methods 400 and 500 and the rest of the methods included herein may be executed by the controller based on instructions stored on a memory of the controller and in conjunction with signals received from sensors of the engine system, such as the sensors described above with reference to FIGS. 1 and 3. The controller may employ actuators such as the motor controller(s) 120, motor(s) 122, brake valves 152A-C, and the like, to alter states of devices in the physical world according to the methods described below.

Method 400 begins at 402 and includes estimating and/or measuring vehicle operating conditions. Vehicle operating conditions may be estimated, measured, and/or inferred, and may include one or more vehicle system conditions and ambient conditions, such as vehicle speed, vehicle location, ambient temperature, ambient pressure, state of charge of the energy storage device (e.g., battery state of charge of the energy storage device 124), temperature of the energy storage device, vehicle longitudinal acceleration, vehicle lateral acceleration, brake pedal position (or percentage), steering angle, accelerator pedal position (or percentage), available powertrain torque, number of primary and auxiliary axles, auxiliary brake temperature, and/or the like.

At 404, method 400 includes determining whether there is a deceleration request. Indication of a deceleration request can be determined at the controller based on input from a brake pedal position sensor and/or an accelerator pedal position sensor. For example, if a vehicle operator presses the brake pedal (e.g., brake pedal 142 depicted in FIGS. 6 and 7), a signal is sent to the controller that is indicative of the brake pedal position (which may be received as a percentage). The controller can then determine a total brake torque request based on the deceleration request.

In some examples, the controller can determine the total brake torque request based on the deceleration request, and also based on vehicle operating conditions such as vehicle speed, mass, road grade, wheel slip, and/or the like.

If it is determined at 404 that there is no deceleration request (for example, the brake pedal position is 0% or unchanged from a previous value), then the method 400 proceeds to 406 to maintain the current vehicle operating conditions. As an example, this may include maintaining the current vehicle torque output based on the accelerator pedal position.

However, if it is determined at 404 that there is a deceleration request, the method 400 continues to 408 to determine whether conditions are met for operating in a “tire life mode” to decelerate or brake the vehicle according to a total brake torque request determined based on the deceleration request. As described herein a “tire life mode” can refer to a braking or deceleration mode of the vehicle (different than the standard braking mode) that is configured bias the total brake torque request toward the auxiliary axles, thereby increasing a longevity of the tires of the primary axles of the vehicle. As described further below, during operation in the tire life mode, the powertrain and braking systems can be actuated such that the determined total brake torque request is biassed toward the auxiliary axles (instead of the drive axles). As a result, a majority of the braking effort can be routed to the friction brakes on the auxiliary axles and the remaining brake torque can be applied to the primary axles. As a result, less recuperative braking effort can be employed and the driven tires on the primary axles can experience reduced wear, and thus a longevity of these tires can be increased. It should be noted that although this mode is termed “tire life mode” herein, in some examples, this braking mode can have a different name while operating in the same way.

Conditions for operating in the tire life mode (TLM) can include one or more of a steering angle of less than a predetermined threshold value (such as 20 degrees, in some examples, which may be indicative of a cornering event), a lateral acceleration less than a predetermined threshold value, no antilock brake system events, no wheel slip condition (e.g., wheel slip below a predetermined threshold wheel slip value), no snow or “wash” environment, and/or ambient temperature above a predetermined threshold value. Wheel slip can be determined based on wheel slip sensors at the vehicle wheels.

In some examples, the predetermined conditions for operating in the TLM include the steering angle less than the threshold steering angle value or the lateral acceleration less than the threshold lateral acceleration value; no antilock brake events or no wheel slip condition; and ambient temperature above the threshold ambient temperature value (or no “wash” environment, or conditions for snow). In some examples, conditions for operating the TLM can additionally or alternatively include a request from the vehicle operator (such as via an operator selectable input on the user interface 114).

If at 408 the conditions for operating in the TLM are not met, the method 400 continues to 410 to operate in the standard brake mode, which is presented as method 500 in FIG. 5 (as described further below).

In some examples, conditions for operating in the TLM may not be met if there are snowy or slippery road conditions, which can be determined based on inputs received from an ambient temperature sensor and/or wheel slip sensor(s). In some examples, conditions for operating in the TLM may not be met if a vehicle operator manually request deactivation of the TLM (for example, via an input to the user interface 114). In some examples, conditions for operating in the TLM may not be met if the steering angle is greater than the predetermined threshold steering angle value or the lateral acceleration is greater than the threshold lateral acceleration value.

Alternatively, if the conditions for operating in the TLM are met at 408, as determined by the controller, the method 400 proceeds to 412 to calculate the auxiliary brake bias factor ([A]). The auxiliary brake bias factor is a parameter that is used to determine how much of the total brake torque request for the deceleration request should be biased or allocated to the auxiliary axles over the primary axles. The auxiliary brake bias factor can be determined based on a variety of inputs, including one or any combination of a battery state of charge (e.g., state of charge percentage for the energy storage device 124), ambient temperature, vehicle speed, vehicle longitudinal acceleration, vehicle lateral acceleration, brake pedal position or percentage, steering angle, available powertrain recuperative torque, number of auxiliary axles, and/or auxiliary brake temperature. In some examples, the auxiliary brake bias factor can be determined based on all the above-listed inputs. In some examples, the auxiliary brake bias factor can be determined based on one, two, three, or four or more of the above-listed inputs. For instance, in one example implementation, the auxiliary brake bias factor is preferably based on a combination of at least vehicle speed, brake pedal position, steering angle, and auxiliary brake temperature.

According to the present disclosure, each input to the auxiliary brake bias factor reflects a physical constraint or optimization tradeoff that can be configured according to a given application. For instance, examples of physical constraints or optimization tradeoffs include, but are not limited to: at high state of charge (SoC), limited regenerative acceptance favors increasing the auxiliary brake bias factor to shift more work to auxiliary friction brakes and maintain deceleration without harsh transitions, whereas at lower SoC the auxiliary brake bias factor can be reduced to exploit greater regenerative capacity on primary axles; low ambient temperatures can depress tire-road friction and change brake heating, so lowering the auxiliary brake bias factor at low ambient preserves stability and avoids cold-friction variability, while moderate temperatures allow a higher auxiliary brake bias factor without overheating; high vehicle speed and/or high longitudinal acceleration increase kinetic energy and load transfer, so slightly reducing the auxiliary brake bias factor in these regimes preserves straight-line stability and minimizes anti-lock braking system (ABS) intervention, whereas at low-to-moderate decelerations a higher auxiliary brake bias factor efficiently moves work to auxiliary brakes for tire-life gains; elevated lateral acceleration or large steering angles signal cornering, so reducing the auxiliary brake bias factor keeps more braking on primary axles (where handling is tuned) and limits auxiliary-axle slip-induced yaw; higher brake pedal positions indicate aggressive stops, so moderating the auxiliary brake bias factor at high inputs stabilizes pedal feel and allocation during emergencies, while allowing a higher auxiliary brake bias factor at gentle to moderate inputs maximizes tire-life benefits; when available recuperative torque on primary axles is high, the auxiliary brake bias factor can be reduced to prioritize energy recovery and lower primary friction wear (subject to maintaining sufficient auxiliary bias), and when regeneration is limited (e.g., based on inverter or acceptance limits) the auxiliary brake bias factor can increase to meet the commanded deceleration via auxiliary friction; with more auxiliary axles, braking can be spread over more hardware and contact patches, reducing per-wheel heating and supporting a higher auxiliary brake bias factor without localized saturation; and if auxiliary brake temperatures rise toward thermal limits, derating the auxiliary brake bias factor protects against fade and hardware damage by shifting work back to primary axles or regeneration until temperatures recover.

For example, the auxiliary brake bias factor can increase (can be determined to be a larger value) for any or all of the following: as the battery state of charge increases, as the ambient temperature increases, as the vehicle speed decreases, as the vehicle longitudinal acceleration decreases, as the vehicle lateral acceleration decreases, as the brake pedal percentage decreases, as the steering angle decreases, as the available powertrain torque for recuperative brake torque decreases, as the number of auxiliary axles increases, and/or as the auxiliary brake temperature decreases. For example, with vehicles having three auxiliary axles compared to only one or two, the auxiliary brake bias factor may be a larger value (e.g., 0.65 instead of 0.6). As another example, the auxiliary brake bias factor can be determined to be a larger value (e.g., 0.7 instead of 0.6) as the vehicle speed and/or brake pedal percentage decreases. In some examples, additional vehicle operating conditions not listed above can influence the calculation of the auxiliary brake bias factor.

In some examples, the auxiliary brake bias factor can be preset at a base value (e.g., 0.6) based on the known structure of the vehicle (e.g., the number of auxiliary axles) and is then adjusted (increased or decreased) based on any combination, or all, of the operating conditions listed above.

In some examples, the auxiliary brake bias factor can be adjusted during operation in the tire life mode based on wheel sleep percentage. Wheel slip (or wheel slip percentage) is estimated based on outputs from individual wheel speed sensors at each wheel end/wheel of the vehicle. For example, the auxiliary brake bias factor can be increased as long as wheel slip is not detected or indicated by the controller. In some examples, wheel slip may be detected or indicated if wheel slip percentage at a wheel is greater than a threshold percentage (e.g., greater than zero, 5%, 10%, or the like). Said another way, during operation in the tire life mode (for example, during operation at 422, as described further below), the auxiliary brake bias factor can be increased until wheel slip is detected. Upon detection of wheel slip, the controller can reduce and/or re-estimate the auxiliary brake bias factor and redistribute brake torque accordingly (for example, repeating the method at 412, 414, and 422, as described below). Thus, in some examples as shown in FIG. 4, the method 400 can optionally include at 424, determining whether wheel slip is detected (for example, whether wheel slip percentage at one or more wheels is greater than the threshold percentage). If wheel slip is detected, the method 400 proceeds to 426 to decrease the auxiliary brake bias factor [A], re-calculate the brake torque requests based on the new [A] value (as described below for the method at 414, 416, 418, and 420), and actuate the motor(s) and brakes to deliver the determined brake torque requests (as described below for the method at 422). Alternatively, if wheel slip is not detected, the method 400 proceeds to 428 to increase the auxiliary brake bias factor [A], re-calculate the brake torque requests based on the new [A] value (as described below for the method at 414, 416, 418, and 420), and actuate the motor(s) and brakes to deliver the determined brake torque requests (as described below for the method at 422).

Returning to 412, in some examples, the auxiliary brake bias factor ([A]) can be calculated or determined based on any one of or combination of the above-listed operating conditions at the powertrain controller (e.g., the powertrain controller 132) and then communicated to the brake controller (e.g., the brake controller 130). In some examples, the controller can determine the auxiliary brake bias factor based on one or more look-up tables stored at the controller. The look-up tables can include one or a combination of the above-described parameters for determining the auxiliary brake bias factor as inputs and the brake bias factor as the output.

The method 400 proceeds to 414 to split or divide the total brake torque request into a primary brake torque request and an auxiliary brake torque request based on the determined auxiliary brake bias factor. As described above with reference to the method at 404, the controller (such as the brake controller 130) can determine the total brake torque request based on the received deceleration request (such as based on a brake pedal percentage from the brake pedal). The controller (e.g., the brake controller 130) can then split the total brake torque request into the primary brake torque request and the auxiliary brake torque request according to the following equations 1 and 2:

$${BkTq}_{aux} = [ A ] * {BkTq}_{total} \qquad ( Equation 1 )$$

$${BkTq}_{primary} = ( 1 - [ A ] ) * {BkTq}_{total} \qquad ( Equation 2 )$$

where BkTq_{primary} is the primary brake torque request, BkTqₐᵤₓ is the auxiliary brake torque request, [A] is the auxiliary brake bias factor, and BkTqₜₒₜₐₗ is the total brake torque request.

In some examples, while operating in a first braking mode (e.g., a tire life mode), the brake controller 130 computes an auxiliary brake torque request by multiplying the total brake torque request (BkTqₜₒₜₐₗ) by an auxiliary brake bias factor [A] that is greater than 0.5, such that BkTqₐᵤₓ=[A]*BkTqₜₒₜₐₗ and BkTq_{primary}=BkTqₜₒₜₐₗ−BkTqₐᵤₓ, with subsequent redistribution across auxiliary wheels 138C and primary axles 136A, 136B, and coordination with available recuperative braking commanded by the powertrain controller 132 to the motor controller 120 and motor(s) 122. The auxiliary brake bias factor [A] is determined adaptively based on inputs that can include battery state of charge for the energy storage device 124, ambient temperature, vehicle speed, longitudinal and lateral acceleration, brake pedal position (or percentage for brake pedal 142), steering angle, available powertrain recuperative torque, number of auxiliary axles, and auxiliary brake temperature, and may be realized via calibrated look-up tables, rule-based logic with hysteresis, or hybrid estimators blending feedforward and feedback. For instance, in one example implementation, the auxiliary brake bias factor is preferably based on one or more of a state of charge of an energy storage device of the powertrain, ambient temperature, vehicle speed, vehicle longitudinal acceleration, vehicle lateral acceleration, and brake pedal position.

Illustratively, the auxiliary brake bias factor [A] tends to increase when state of charge is high, when additional auxiliary axles are present, or when available recuperative torque is limited, and tends to decrease with larger steering angles or higher lateral acceleration, higher speeds or aggressive brake pedal inputs, or when substantial recuperative torque is available on the primary axles. Ambient and auxiliary brake temperatures can adjust the auxiliary brake bias factor [A] through thermal derating to prevent overheating. For smoothness and robustness, the auxiliary brake bias factor [A] can be filtered and gated by enable/disable thresholds and dwell timers (e.g., requiring steering angle and lateral acceleration to remain below thresholds before permitting the auxiliary brake bias factor [A]>0.5, and imposing a re-enable dwell following ABS events). During a braking event, the auxiliary brake bias factor [A] may be held constant for pedal-feel stability or updated in-cycle based on wheel slip (from speed sensors 140), temperature, or recuperative availability, with the allocator enforcing the auxiliary brake bias factor [A]>0.5 whenever the first braking mode is active and reducing or clamping the auxiliary brake bias factor [A] to 0.5—or transitioning out of the first braking mode—whenever enable conditions are no longer satisfied.

The method 400 at 414 can include further splitting the determined primary brake torque request and auxiliary brake torque request into recuperative and friction brake torque requests for the various axles. For example, at 416 the method 400 includes setting the primary recuperative brake torque request (for the driven primary axle(s)) to the available recuperative brake torque. The available recuperative brake torque can be determined by the controller (e.g., the powertrain controller 132) based on a state of the energy storage device and motor(s) (for example, a battery state of charge of the energy storage device, a temperature of the energy storage device, a temperature of the motor(s) and/or the like). The primary recuperative brake torque request can be the recuperative brake torque request to be sent to the motor(s) of the driven primary axles (e.g., primary axles 136A).

At 418, the method 400 includes distributing the remaining primary brake torque request between the primary axle(s) friction brakes (e.g., brakes 134A). For example, any of the remaining primary brake torque request, after subtracting the recuperative brake torque request, can be split between the friction brakes on the primary axles. In some examples, if the primary axles of the vehicle include a steer axle and one or more drive axles, the remaining primary brake torque request can be split between the steer axle and drive axle(s) based on vehicle operating conditions. For example, based on wheel slip, driving conditions (ambient temperature and/or pressure), and/or the like, the controller can allocate a specified amount of the remaining primary brake torque request to the steer axle to maintain vehicle stability and then distribute to remaining primary brake torque request among the drive axles. An example of such distribution is described further below with reference to FIG. 7.

At 420, the method 400 includes distributing or splitting the determined auxiliary brake torque request evenly between the known number of auxiliary axles. For example, half the determined auxiliary brake torque request can be allocated to each auxiliary axle if the vehicle has two auxiliary axles.

Proceeding to 422, the method 400 includes actuating the motor(s) (e.g., via electrical signals sent to the motor(s) 122) and brakes (e.g., via electrical signals sent to brake valves 152A, 152B, 152C) to deliver the brake torque requests determined at 416, 418, and 420. An example of this distribution to the various motors and brake valves of the braking system is depicted in FIG. 7, as described further below. As a result, the total brake torque request can be delivered, and the deceleration request can be fulfilled while minimizing the wear on the tires of the primary axles (particularly, the drive axles).

As described above, in some examples, the method 400 can optionally include determining whether wheel slip is detected at 424 and then adjusting the auxiliary brake bias factor [A], and the corresponding brake torque requests, based on the detected wheel sleep percentage (as shown at 426 and 428 in FIG. 4 and described above).

As introduced above, if conditions for operating in the TLM are not met at 408 of method 400, the controller operates the vehicle system in the standard brake mode, which is depicted in detail by method 500 of FIG. 5. The method 500 begins at 502 by determining the total brake torque request based on the received deceleration request. For example, as described above at 404 of method 400, the controller can determine the total brake torque request based on inputs from a brake pedal position sensor (e.g., brake pedal percentage) and/or an accelerator pedal position sensor. In some examples, the controller can determine the total brake torque request based on the deceleration request, and also based on vehicle operating conditions such as vehicle speed, mass, road grade, wheel slip, and/or the like.

The method 500 continues to 504 to distribute or split the total brake torque request evenly between the known axles (primary and auxiliary axles) of the vehicle system. For example, as described further below with reference to the example presented at FIG. 6, the controller (e.g., brake controller) can split the determined total brake torque request evenly between the steer axle (if present), drive axles, and auxiliary axle (the controller may assume one auxiliary axle, even if the vehicle has two or more auxiliary axles). Thus, for a 20.00 Nm total brake torque request, each of the steer axle, drives axles (for an example vehicle system with two drive axles), and auxiliary axle receive 5,000 Nm of brake torque.

However, since the drive axles of the primary axles can have brake torque applied by recuperative braking (via the motor) and the friction brakes, the method 500 continues to 506 to split the brake torque request to the primary drive axle(s) into recuperative brake torque and friction brake torque, based on the available recuperative brake torque. As described above with reference to the method 400 at 416, the available recuperative brake torque can be determined by the controller (e.g., the powertrain controller 132) based on a state of the energy storage device and motor(s) (for example, a battery state of charge of the energy storage device, a temperature of the energy storage device, a temperature of the motor(s) and/or the like). The controller may prioritize recuperative brake torque over friction brake torque (for example, apply more of the primary drive axle brake torque request as recuperative brake torque than friction brake torque). For example, in some examples, this may include applying all the primary drive axle brake torque request as recuperative brake torque. In some examples, this may include simultaneously applying recuperative brake torque and friction brake torque to the primary drive axles to deliver the primary drive axle brake torque request. In some examples, if the available recuperative brake torque is zero or below a non-zero threshold value, this may include applying all the primary drive axle brake torque request as friction brake torque.

Proceeding to 508, the method 500 includes actuating the motor(s) (e.g., via electrical signals sent to the motor(s) 122) and brakes (e.g., via electrical signals sent to brake valves 152A, 152B, 152C) to deliver the brake torque requests determined at 504 and 506. An example of this distribution to the various motors and brake valves of the braking system is depicted in FIG. 6, as described further below. As a result, the total brake torque request can be delivered, and the deceleration request can be fulfilled. However, as shown in the example of FIG. 6, since the brake torque request to the driven primary axles via recuperative braking can be larger in the standard operating mode than the tire life mode, increased wear to the drive tires can occur at 508.

At 510, the method 500 includes determining whether the recuperative braking effort (delivered via the motor(s)) can fulfil the primary recuperative brake torque request (which was determined at 506). If the recuperative brake effort is not delivering the requested primary recuperative brake torque request, the method 500 proceeds to 512 to increase the primary axle friction brake torque request and actuate the friction brakes on the primary axles to deliver the increased brake torque. For example, electrical signals can be sent to the primary axle friction brake valves (e.g., primary brake valves 152A) to increase friction braking on the primary axle(s). The method 500 can then circle back to 510.

Alternatively, if the recuperative brake effort is delivering the requested primary recuperative brake torque request, the method 500 proceeds to 514 to determine whether wheel slip is detected. Wheel slip may be detected by the controller based on signals received from individual wheel speed sensors at the vehicle wheels. For example, a wheel slip percentage at one or more of the vehicle wheels can be estimated based on outputs from the individual wheel speed sensors at each wheel. In some examples, wheel slip may be detected or indicated if wheel slip percentage at a wheel is greater than a threshold percentage (e.g., greater than zero, 5%, 10%, or the like). If no wheel slip is detected, the method 500 continues to 516 to continue actuating the motor(s) and brakes until the deceleration request is fulfilled.

However, if wheel slip at one or more wheels is detected, the method 500 proceeds to 518 to adjust the brake torque delivered to one or more wheels or axles based on wheel sleep. For example, if wheel slip is detected on a wheel of the auxiliary axle, the controller may actuate the brake valve for that axle or wheel to decrease the delivered brake torque and actuate another brake valve for a different axle (such as a steer axle or drive axle of the primary axles) to proportionally increase brake torque delivered to that different axle. The method 500 then circles back to 514 to determine if wheel slip is still detected and adjust operation accordingly.

Turning to FIG. 6, an example of operation in the standard braking mode (as described above with reference to the method 500 of FIG. 5) is depicted by schematic 600. As shown in schematic 600, a deceleration request of −1.0 m/s² can be determined based on a signal received at the brake controller 130 from the brake pedal 142 (e.g., the brake pedal position sensor of the brake pedal 142). The brake controller 130 converts the deceleration request to a total brake torque request to achieve the deceleration request (shown as BkTqₜₒₜₐₗ in FIG. 6). The controller determines that the total brake torque request is 20,000 Nm.

The powertrain controller 132 communicates the available recuperative brake torque (10,000 Nm in this example) based on known operating conditions (e.g., battery state of charge of the energy storage device, temperature of the energy storage device and motors, and/or the like). The brake controller 130 determines the brake torque to be applied for each of the steer axle, drive axle(s), and auxiliary axle(s). Specifically, in the standard braking mode, the brake controller 130 splits the total brake torque request (20,000 Nm) evenly between the steer axle, drives axles (two known drive axles in this example), and auxiliary axle (one known auxiliary axle in this example). This results in 5,000 Nm of steer brake torque applied to the friction brakes 134B of the steer axle, as shown at 602, 10,000 Nm of drive brake torque applied to the drive axles, as shown at 604 (5,000 Nm to each of the two drive axles), and 5,000 Nm of auxiliary brake torque applied to the friction brakes 134C of the auxiliary axle, as shown at 606. If the vehicle system includes more than one auxiliary axle (but it is still only seen as one axle at the controller), the 5,000 Nm is split between all the available friction brakes on the auxiliary axle(s).

The brake controller 130 splits the drive brake torque (10,000 Nm, as shown at 604) into recuperative brake torque and friction brake torque to the drive axles. The brake controller 130 prioritizes the recuperative brake torque by applying more recuperative brake torque than friction brake torque for the total drive brake torque. In this example, this equates to 8,000 Nm of recuperative brake torque, as shown at 608 (e.g., 4,000 Nm delivered by each motor of each of the two drive axles), and 2,000 Nm of friction brake torque, as shown at 610 (split between all the friction brakes 134A of the drive axles).

FIG. 7 depicts, via schematic 700, an example of operation in the tire life mode (“TLM,” as described above with reference to the method 400 of FIG. 4). As shown in schematic 700, a deceleration request of −1.0 m/s² can be determined based on a signal received at the brake controller 130 from the brake pedal 142 (e.g., the brake pedal position sensor of the brake pedal 142). The brake controller 130 converts the deceleration request to a total brake torque request to achieve the deceleration request (shown as BkTqₜₒₜₐₗ in FIG. 7). The controller determines that the total brake torque request is 20,000 Nm (the same as in the standard brake mode example of FIG. 6).

The powertrain controller 132 communicates the available recuperative brake torque (10,000 Nm in this example) based on known operating conditions (e.g., battery state of charge of the energy storage device, temperature of the energy storage device and motors, and/or the like). The powertrain controller 132 also calculates the auxiliary brake bias factor [A], as described above at 412 of method 400 (FIG. 4). As shown in the example of FIG. 7, the brake bias factor [A] is determined to be 0.6.

The controller (e.g., brake controller 130) determines the primary brake torque request and the auxiliary brake torque request based on the auxiliary brake bias factor [A]. Since the total brake torque request is 20,000 Nm and the brake bias factor [A] is 0.6, the primary brake torque request is 8,000 Nm and the auxiliary brake torque request is 12,000 Nm. The auxiliary brake torque request (12,000 Nm) is applied to the friction brakes 134C of the auxiliary axle, as shown at 706. If the vehicle system includes more than one auxiliary axle (but it is still only seen as one axle at the controller), the 12,000 Nm is split between all the available friction brakes 134C on the auxiliary axle(s).

The brake controller 130 splits the primary brake torque request (8,000 Nm) into the steer brake torque request (5,000 Nm), as show at 702, to be applied to the friction brakes 134B of the steer axle, and the drive brake torque request (3,000 Nm), as shown at 704. The brake controller 130 splits the drive brake torque (3,000 Nm) into recuperative brake torque and friction brake torque to the drive axles. The brake controller 130 prioritizes the recuperative brake torque by applying more recuperative brake torque than friction brake torque for the total drive brake torque. In this example, this equates to 3,000 Nm of recuperative brake torque, as shown at 708 (e.g., 1,500 Nm delivery by each motor of each of the two drive axles), and zero friction brake torque, as shown at 710.

In this way, for a same deceleration request and total brake torque request, the amount of brake torque applied to the auxiliary axles vs. the primary axles is greater in the tire life mode than in the standard braking mode. Further, the amount of recuperative brake torque applied to the drive axles is smaller in the tire life mode than in the standard braking mode. As a result, reduced tire wear (through reduced recuperative braking effort) occurs at the drive wheels when operating in the tire life mode. As a result, a longevity of the drive tires can be increased, thereby reducing vehicle system costs.

### Additional Examples of the Disclosed Technology

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

The features described herein with regard to any example can be combined with other features described in any one or more of the other examples, unless otherwise stated. For example, any one or more features of one vehicle can be combined with any one or more features of another vehicle.
Clause 1. A vehicle system comprising: a vehicle chassis comprising one or more primary axles and one or more auxiliary axles; a powertrain comprising at least one electric motor coupled to the one or more primary axles; a friction braking system comprising a plurality of friction brakes, wherein each friction brake is coupled to a respective wheel on each of the one or more primary axles and the one or more auxiliary axles; and a controller comprising a non-transitory storage medium with computer-readable instructions for: in response to a deceleration request and predetermined vehicle operating conditions for operation in a first braking mode being met, actuating a first portion of the plurality of friction brakes to apply a first brake torque to at least one of the one or more auxiliary axles and actuating the at least one electric motor and a second portion of the plurality of friction brakes to apply a remaining, second brake torque to the one or more primary axles, wherein the first brake torque is greater than the second brake torque, and wherein the first and second brake torque equal a total brake torque request for the deceleration request.
Clause 2. The vehicle system of clause 1, wherein the first brake torque is determined by multiplying the total brake torque request by an auxiliary brake bias factor that is greater than 0.5, and wherein the auxiliary brake bias factor is based on one or more of a state of charge of an energy storage device of the powertrain, ambient temperature, vehicle speed, vehicle longitudinal acceleration, vehicle lateral acceleration, brake pedal position, steering angle, available powertrain recuperative torque, a number of auxiliary axles, and auxiliary brake temperature.
Clause 3. The vehicle system of any proceeding clause, wherein the predetermined vehicle operating conditions include: a steering angle less than a threshold steering angle value or a lateral acceleration less than a threshold lateral acceleration value; no antilock brake events or wheel slip below a threshold wheel slip value; and ambient temperature above a threshold ambient temperature value.
Clause 4. The vehicle system of any proceeding clause, wherein the computer-readable instructions further include instructions for: in the response to the deceleration request and the predetermined vehicle operating conditions for operation in the first braking mode not being met, operating in a second braking mode including actuating the plurality of friction brakes and the at least one electric motor to deliver a total torque request for the deceleration request such that an equal amount of brake torque is applied to each axle of the one or more primary axles and the one or more auxiliary axles.
Clause 5. The vehicle system of any proceeding clause, wherein the friction braking system is an electropneumatic braking system comprising a plurality of electropneumatic valves, each electropneumatic valve coupled to a friction brake on a respective wheel of the vehicle system, and wherein actuating the first portion of friction brakes and the second portion of friction brakes includes actuating the first portion and the second portion of friction brakes by sending electrical signals to the plurality of electropneumatic valves.
Clause 6. The vehicle system of any proceeding clause, wherein the one or more primary axles includes one or more drive axles coupled to the at least one electric motor, and a steer axle; and wherein the steer axle is not coupled to the at least one electric motor.
Clause 7. A method comprising: responsive to a deceleration request received at a controller of a vehicle and a predetermined first set of vehicle operating conditions being met: determining an auxiliary brake bias factor based on a second set of vehicle operating conditions, wherein the vehicle comprises one or more primary axles that are driven by one or more electric motors of the vehicle and one or more auxiliary axles that are non-driven axles of the vehicle; determining a primary brake torque request and an auxiliary brake torque request based on a total brake torque request that is based on the deceleration request, and the determined auxiliary brake bias factor, wherein the auxiliary brake torque request is greater than the primary brake torque request; actuating a friction braking system of the vehicle to apply friction brakes on the one or more auxiliary axles to deliver the auxiliary brake torque request evenly across the friction brakes on the one or more auxiliary axles; actuating the one or more electric motors to deliver a first amount of the primary brake torque request as recuperative brake torque to the one or more primary axles, wherein the first amount is equal to an available amount of the recuperative brake torque; and actuating the friction braking system to apply friction brakes on the one or more primary axles to deliver a remaining amount of the primary brake torque request.
Clause 8. The method of clause 7, wherein the second set of vehicle operating conditions includes two or more of a state of charge of an energy storage device coupled to the one or more electric motors, ambient temperature, vehicle speed, vehicle longitudinal acceleration, vehicle lateral acceleration, brake pedal position, steering angle, available powertrain recuperative torque, a number of auxiliary axles, and auxiliary brake temperature.
Clause 9. The method of any proceeding clause, wherein determining the auxiliary brake bias factor based on the second set of vehicle operating conditions includes increasing the auxiliary brake bias factor as one or more of the following increases: the state of the charge of the energy storage device, the ambient temperature, and the number of auxiliary axles.
Clause 10. The method of any proceeding clause, wherein determining the auxiliary brake bias factor based on the second set of vehicle operating conditions includes increasing the auxiliary brake bias factor as one or more of the following decreases: the vehicle speed, the vehicle longitudinal acceleration, the vehicle lateral acceleration, the brake pedal position, the steering angle, the available powertrain recuperative torque for the recuperative brake torque, and the auxiliary brake temperature.
Clause 11. The method of any proceeding clause, wherein the first set of vehicle operating conditions includes: a steering angle less than a threshold steering angle value or a lateral acceleration less than a threshold lateral acceleration value; no antilock brake events or wheel slip below a threshold wheel slip value; and ambient temperature above a threshold ambient temperature value.
Clause 12. The method of any proceeding clause, wherein the friction braking system is an electropneumatic braking system comprising a plurality of electropneumatic valves, each electropneumatic valve coupled to a friction brake on a respective wheel of the vehicle, and wherein actuating the friction braking system includes sending electrical signals to specified electropneumatic valves to actuate the friction brakes on the one or more auxiliary axles and the one or more primary axles.
Clause 13. The method of any proceeding clause, further comprising, responsive to a deceleration request received at the controller of the vehicle and the predetermined first set of vehicle operating conditions not being met: determining a total brake torque request based on the deceleration request and splitting the total brake torque request evenly between each known auxiliary axle of the one or more auxiliary axles and each primary axle of the one or more primary axles of the vehicle to determine an auxiliary brake torque request and a primary brake torque request, wherein the primary brake torque request is equal to or greater than the auxiliary brake torque request; actuating the friction braking system to apply friction brakes on the one or more auxiliary axles to deliver the auxiliary brake torque request evenly across the friction brakes on the one or more auxiliary axles; actuating the one or more electric motors to deliver a second amount of the primary brake torque request as recuperative brake torque to the one or more primary axles, wherein the second amount is based on the available amount of recuperative brake torque; and actuating the friction braking system to apply friction brakes on the one or more primary axles to deliver a remaining amount of the primary brake torque request.
Clause 14. The method of any proceeding clause, wherein for a same deceleration request, the second amount of the recuperative brake torque is greater than the first amount of the recuperative brake torque.
Clause 15. A controller of a vehicle system, comprising: at least one memory; and at least one processor couples with the at least one memory and configured to: in response to a deceleration request when predetermined operating conditions of a vehicle system for operating in a first braking mode are present, operating in the first braking mode by actuating brake valves of a friction braking system of the vehicle system and one or more electric motors of a powertrain of the vehicle system so that a majority of a total brake torque request that is determined based on the deceleration request is applied to non-driven, auxiliary axles of the vehicle system and a remainder of the total brake torque request is applied to primary axles of the vehicle system, and wherein a first portion of the remainder of the total brake torque request applied to the primary axles is recuperative brake torque applied by the one or more electric motors and a second portion of the remainder of the total brake torque request applied to the primary axles is friction brake torque applied by the brake valves; and in response to the deceleration request when the predetermined operating conditions for operating in the first braking mode are not present, operating in a second braking mode by actuating the brake valves of the friction braking system and the one or more electric motors of the powertrain of the vehicle system so that a total brake torque request determined based on the deceleration request is applied evenly across all known axles as a primary brake torque request to the primary axles and an auxiliary brake torque request to the auxiliary axles, and wherein the first portion of the primary brake torque request applied to the primary axles is the recuperative brake torque applied by the one or more electric motors and the second portion of the primary brake torque request applied to the primary axles is the friction brake torque applied by the brake valves.
Clause 16. The controller of clause 15, wherein for the same deceleration request and determined total brake torque request, the first portion of the primary brake torque request applied to the primary axles as recuperative brake torque during operating in the second braking mode is greater than the first portion of the remainder of the total brake torque request applied to the primary axles as the recuperative brake torque during operation in the first braking mode.
Clause 17. The controller of any preceding clause, wherein during operating in the first braking mode, the majority of the total brake torque request is determined based on an auxiliary brake bias factor that is determined based on a state of charge of an energy storage device of the powertrain, ambient temperature, vehicle speed, vehicle longitudinal acceleration, vehicle lateral acceleration, brake pedal position, steering angle, available powertrain recuperative torque, a number of auxiliary axles, and auxiliary brake temperature.
Clause 18. The controller of any proceeding clause, further comprising adjusting the brake bias factor based on a wheel slip percentage at one or more wheels of the vehicle system during operating in the first braking mode.
Clause 19. The controller of any proceeding clause, wherein the predetermined operating conditions for operating in the first braking mode include: a steering angle less than a threshold steering angle value or a lateral acceleration less than a threshold lateral acceleration value; no antilock brake events or wheel slip; and ambient temperature above a threshold ambient temperature value.
Clause 20. The controller of any proceeding clause, wherein during the first braking mode, the first portion of the remainder of the total brake torque request applied to the primary axles is greater than the second portion of the remainder of the total brake torque request applied to the primary axles, and wherein during the second braking mode, the first portion of the primary brake torque request applied to the primary axles is greater than the second portion of the primary brake torque request applied to the primary axles.

### Explanation of Terms

For purposes of this description, certain aspects, advantages, and novel features of the aspects of this disclosure are described herein. The disclosed methods, apparatus, and systems should not be construed as being limiting in any way. Instead, the present disclosure is directed toward all novel and nonobvious features and aspects of the various disclosed aspects, alone and in various combinations and sub-combinations with one another. The methods, apparatus, and systems are not limited to any specific aspect or feature or combination thereof, nor do the disclosed aspects require that any one or more specific advantages be present or problems be solved. The scope of this disclosure includes any features disclosed herein combined with any other features disclosed herein, unless physically impossible.

Although the operations of some of the disclosed aspects are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

As used in this disclosure and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In the description, certain terms may be used such as “forward,” “front,” “rear,” “back,” “up,” “down,” “upper,” “lower,” “horizontal,” “vertical,” “left,” “right,” “longitudinal,” “lateral,” and the like. These terms are used, where applicable, to provide some clarity of description when dealing with relative relationships. However, these terms are not intended to imply absolute relationships, positions, and/or orientations. For example, with respect to an object, an “upper” surface can become a “lower” surface by turning the object over. Nevertheless, it is still the same object.

Similar components in different aspects are described in the specification and illustrated in the figures with similar reference numbers for improved understanding and readability. However, it should be understood that this numbering convention is merely for convenience and is not intended to limit and/or exclude any claim scope.

Although there are alternatives for various components, parameters, operating conditions, etc., set forth herein, that does not mean that those alternatives are necessarily equivalent and/or perform equally well. Nor does it mean that the alternatives are listed in a preferred order unless stated otherwise.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

We claim:

1. A vehicle system comprising:
a vehicle chassis comprising one or more primary axles and one or more auxiliary axles;
a powertrain comprising at least one electric motor coupled to the one or more primary axles;
a friction braking system comprising a plurality of friction brakes, wherein each friction brake is coupled to a respective wheel on each of the one or more primary axles and the one or more auxiliary axles; and
a controller comprising a non-transitory storage medium with computer-readable instructions for:
in response to a deceleration request and predetermined vehicle operating conditions for operation in a first braking mode being met, actuating a first portion of the plurality of friction brakes to apply a first brake torque to at least one of the one or more auxiliary axles and actuating the at least one electric motor and a second portion of the plurality of friction brakes to apply a remaining, second brake torque to the one or more primary axles, wherein the first brake torque is greater than the second brake torque, and wherein the first and second brake torque equal a total brake torque request for the deceleration request.

2. The vehicle system of claim 1, wherein the first brake torque is determined by multiplying the total brake torque request by an auxiliary brake bias factor that is greater than 0.5, and wherein the auxiliary brake bias factor is based on one or more of a state of charge of an energy storage device of the powertrain, ambient temperature, vehicle speed, vehicle longitudinal acceleration, vehicle lateral acceleration, brake pedal position, steering angle, available powertrain recuperative torque, a number of auxiliary axles, and auxiliary brake temperature.

3. The vehicle system of claim 1, wherein the predetermined vehicle operating conditions include:
a steering angle less than a threshold steering angle value or a lateral acceleration less than a threshold lateral acceleration value;
no antilock brake events or wheel slip below a threshold wheel slip value; and
ambient temperature above a threshold ambient temperature value.

4. The vehicle system of claim 1, wherein the computer-readable instructions further include instructions for: in the response to the deceleration request and the predetermined vehicle operating conditions for operation in the first braking mode not being met, operating in a second braking mode including actuating the plurality of friction brakes and the at least one electric motor to deliver a total torque request for the deceleration request such that an equal amount of brake torque is applied to each axle of the one or more primary axles and the one or more auxiliary axles.

5. The vehicle system of claim 1, wherein the friction braking system is an electropneumatic braking system comprising a plurality of electropneumatic valves, each electropneumatic valve coupled to a friction brake on a respective wheel of the vehicle system, and wherein actuating the first portion of friction brakes and the second portion of friction brakes includes actuating the first portion and the second portion of friction brakes by sending electrical signals to the plurality of electropneumatic valves.

6. The vehicle system of claim 1, wherein the one or more primary axles includes one or more drive axles coupled to the at least one electric motor, and a steer axle; and wherein the steer axle is not coupled to the at least one electric motor.

7. A method comprising:
responsive to a deceleration request received at a controller of a vehicle and a first set of vehicle operating conditions being met:
determining an auxiliary brake bias factor based on a second set of vehicle operating conditions, wherein the vehicle comprises one or more primary axles that are driven by one or more electric motors of the vehicle and one or more auxiliary axles that are non-driven axles of the vehicle;
determining a primary brake torque request and an auxiliary brake torque request based on a total brake torque request that is based on the deceleration request, and the auxiliary brake bias factor, wherein the auxiliary brake torque request is greater than the primary brake torque request;
actuating a friction braking system of the vehicle to apply friction brakes on the one or more auxiliary axles to deliver the auxiliary brake torque request evenly across the friction brakes on the one or more auxiliary axles;
actuating the one or more electric motors to deliver a first amount of the primary brake torque request as recuperative brake torque to the one or more primary axles, wherein the first amount is equal to an available amount of the recuperative brake torque; and
actuating the friction braking system to apply the friction brakes on the one or more primary axles to deliver a remaining amount of the primary brake torque request.

8. The method of claim 7, wherein the second set of vehicle operating conditions includes two or more of a state of charge of an energy storage device coupled to the one or more electric motors, ambient temperature, vehicle speed, vehicle longitudinal acceleration, vehicle lateral acceleration, brake pedal position, steering angle, available powertrain recuperative torque, a number of auxiliary axles, and auxiliary brake temperature.

9. The method of claim 8, wherein determining the auxiliary brake bias factor based on the second set of vehicle operating conditions includes increasing the auxiliary brake bias factor as one or more of the following increases: the state of the charge of the energy storage device, the ambient temperature, and the number of auxiliary axles.

10. The method of claim 8, wherein determining the auxiliary brake bias factor based on the second set of vehicle operating conditions includes increasing the auxiliary brake bias factor as one or more of the following decreases: the vehicle speed, the vehicle longitudinal acceleration, the vehicle lateral acceleration, the brake pedal position, the steering angle, the available powertrain recuperative torque for the recuperative brake torque, and the auxiliary brake temperature.

11. The method of claim 7, wherein the first set of vehicle operating conditions includes:
a steering angle less than a threshold steering angle value or a lateral acceleration less than a threshold lateral acceleration value;
no antilock brake events or wheel slip below a threshold wheel slip value; and
ambient temperature above a threshold ambient temperature value.

12. The method of claim 7, wherein the friction braking system is an electropneumatic braking system comprising a plurality of electropneumatic valves, each electropneumatic valve coupled to a friction brake on a respective wheel of the vehicle, and wherein actuating the friction braking system includes sending electrical signals to specified electropneumatic valves to actuate the friction brakes on the one or more auxiliary axles and the one or more primary axles.

13. The method of claim 7, further comprising, responsive to the deceleration request received at the controller of the vehicle and the first set of vehicle operating conditions not being met:
determining the total brake torque request based on the deceleration request and splitting the total brake torque request evenly between each known auxiliary axle of the one or more auxiliary axles and each primary axle of the one or more primary axles of the vehicle to determine the auxiliary brake torque request and the primary brake torque request, wherein the primary brake torque request is equal to or greater than the auxiliary brake torque request;
actuating the friction braking system to apply the friction brakes on the one or more auxiliary axles to deliver the auxiliary brake torque request evenly across the friction brakes on the one or more auxiliary axles;
actuating the one or more electric motors to deliver a second amount of the primary brake torque request as the recuperative brake torque to the one or more primary axles, wherein the second amount is based on the available amount of the recuperative brake torque; and
actuating the friction braking system to apply friction brakes on the one or more primary axles to deliver the remaining amount of the primary brake torque request.

14. The method of claim 13, wherein for a same deceleration request, the second amount of the recuperative brake torque is greater than the first amount of the recuperative brake torque.

15. A controller of a vehicle system, comprising:
at least one memory; and
at least one processor couples with the at least one memory and configured to:
in response to a deceleration request when predetermined operating conditions of the vehicle system for operating in a first braking mode are present, operating in the first braking mode by actuating brake valves of a friction braking system of the vehicle system and one or more electric motors of a powertrain of the vehicle system so that a majority of a total brake torque request that is determined based on the deceleration request is applied to non-driven, auxiliary axles of the vehicle system and a remainder of the total brake torque request is applied to primary axles of the vehicle system, and wherein a first portion of the remainder of the total brake torque request applied to the primary axles is recuperative brake torque applied by the one or more electric motors and a second portion of the remainder of the total brake torque request applied to the primary axles is friction brake torque applied by the brake valves; and
in response to the deceleration request when the predetermined operating conditions for operating in the first braking mode are not present, operating in a second braking mode by actuating the brake valves of the friction braking system and the one or more electric motors of the powertrain of the vehicle system so that a total brake torque request determined based on the deceleration request is applied evenly across all known axles as a primary brake torque request to the primary axles and an auxiliary brake torque request to the auxiliary axles, and wherein the first portion of the primary brake torque request applied to the primary axles is the recuperative brake torque applied by the one or more electric motors and the second portion of the primary brake torque request applied to the primary axles is the friction brake torque applied by the brake valves.

16. The controller of claim 15, wherein for a same deceleration request and a same total brake torque request, the first portion of the primary brake torque request applied to the primary axles as the recuperative brake torque during operating in the second braking mode is greater than the first portion of the remainder of the total brake torque request applied to the primary axles as the recuperative brake torque during operation in the first braking mode.

17. The controller of claim 15, wherein during operating in the first braking mode, the majority of the total brake torque request is determined based on an auxiliary brake bias factor that is determined based on a state of charge of an energy storage device of the powertrain, ambient temperature, vehicle speed, vehicle longitudinal acceleration, vehicle lateral acceleration, brake pedal position, steering angle, available powertrain recuperative torque, a number of auxiliary axles, and auxiliary brake temperature.

18. The controller of claim 17, further comprising adjusting the auxiliary brake bias factor based on a wheel slip percentage at one or more wheels of the vehicle system during operating in the first braking mode.

19. The controller of claim 15, wherein the predetermined operating conditions for operating in the first braking mode include:
a steering angle less than a threshold steering angle value or a lateral acceleration less than a threshold lateral acceleration value;
no antilock brake events or wheel slip; and
ambient temperature above a threshold ambient temperature value.

20. The controller of claim 15, wherein during the first braking mode, the first portion of the remainder of the total brake torque request applied to the primary axles is greater than the second portion of the remainder of the total brake torque request applied to the primary axles, and wherein during the second braking mode, the first portion of the primary brake torque request applied to the primary axles is greater than the second portion of the primary brake torque request applied to the primary axles.
